(19) United States
(12) Patent Application Publication
(10) Pub. No.: US 2026/0218873 A1
(43) Pub. Date: Jul. 30, 2026

(54) MICRO-LED LIGHT STRIPS OR FIXTURES FOR THE TRANSPORTATION INDUSTRY

(71) Applicant: VueReal Inc., Waterloo (CA)

(72) Inventors: Gholamreza CHAJI, Waterloo (CA); John CRONIN, Jericho, VT (US)

(73) Assignee: VueReal Inc., Waterloo, ON (CA)

(21) Appl. No.: 19/142,254

(22) PCT Filed: Dec. 20, 2023
(86) PCT No.: PCT/CA2023/051711

§ 371 Date: Jun. 23, 2025

Related U.S. Application Data
(60) Provisional application No. 63/477,018, filed on Dec. 23, 2022.

(51) Int. Cl. F21S 43/14; F21S 43/15; F21S 43/19; F21S 43/20; F21V 21/08; F21V 23/00; F21W 104/00; F21Y 103/10

(52) U.S. Cl. CPC F21S 43/14; F21S 43/15; F21S 43/195; F21S 43/28135; F21S 43/2817; F21V 21/0808; F21V 23/005; F21S 2243/00; F21W 2104/00; F21Y 2103/10

(57) ABSTRACT

The present disclosure provides an aesthetic micro-LED lighting strip for transportation vehicles in which the aesthetic micro-LED lighting strip includes a substrate, a plurality of micro-LED tiles, an adhesive strip, a protective layer, a connection means to connect the micro-LED tiles that are integrated into a transportation vehicle to provide aesthetic lighting on the exterior of the vehicle.

### BACKGROUND AND FIELD OF THE DISCLOSURE

The present disclosure is generally related to an aesthetic micro-LED lighting strip for transportation vehicles.

The transportation industry is any industry, business, or establishment operated to convey persons or property from one place to another, whether by rail, highway, air, or water, and all operations and services in connection in addition to that; and also includes storing or warehousing of goods or property, and the repairing, parking, rental, maintenance, or cleaning of vehicles. The exterior of a vehicle may be the front, rear, sides, roof, or underside of any vehicle. In the transportation industry, there is a need for exterior aesthetic lighting, which requires a wide range of sizes, shapes, colors, etc., that need to be attached to all regions of the exterior of a vehicle.

Currently, aesthetic lighting is provided by LEDs or light bulbs which are expensive and may be too bulky for some exterior components of the vehicles, which results in a limitation of locations where aesthetic lighting can be positioned on the exterior of a vehicle.

Lastly, the current aesthetic lighting in the transportation industry produces a great amount of heat which can damage the aesthetic lighting or the body parts or components of the vehicle over time. These aesthetic lighting apparatuses also use lots of power to produce aesthetic lighting, which may cause issues for the vehicle owner.

Thus, there is a need in the prior art to provide an aesthetic micro-LED lighting strip for transportation vehicles.

### SUMMARY

The present invention is related to a method to integrate aesthetic micro-LED lighting strip lighting strip for a transportation vehicle, the method comprising, having a micro-LED strip with a substrate, a plurality of micro-LED tiles and a protective layer, having an adhesive strip in the micro-LED strip, having a connection means to connect the micro-LED tiles, and wherein, the micro-LED lighting strip is attached to the transportation vehicle through the adhesive strip to provide a required lighting.

### DESCRIPTIONS OF THE DRAWINGS

FIG. 1: Illustrates an integration of a transferred microdevice with an electro-optical thin film device in a hybrid structure, according to an embodiment.

FIG. 2: Illustrates an embodiment of a rigid flat Micro-LED for exterior strip lighting

FIG. 3: Illustrates a flexible flat micro-LED for exterior strip lighting for a vehicle, according to an embodiment.

FIG. 4: Illustrates making micro-LED flexible exterior strip units, according to an embodiment.

FIG. 5: Illustrates a micro-LED with a substrate colored to be the same color as the vehicle positioned on a vehicle, according to an embodiment.

FIG. 6: Illustrates a micro-LED strip with a transparent substrate to match the clear glass of a vehicle, according to an embodiment.

FIG. 7: Illustrates a micro-LED strip with a color pixel array in an exterior strip lighting unit for vehicles, according to an embodiment.

FIG. 8: Illustrates a micro-LED with a color pixel array integrated into a body part attachment of a vehicle, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples. The present disclosure describes a structure, system and a method to integrate micro-LED interior and exterior lighting into the transportation vehicle.

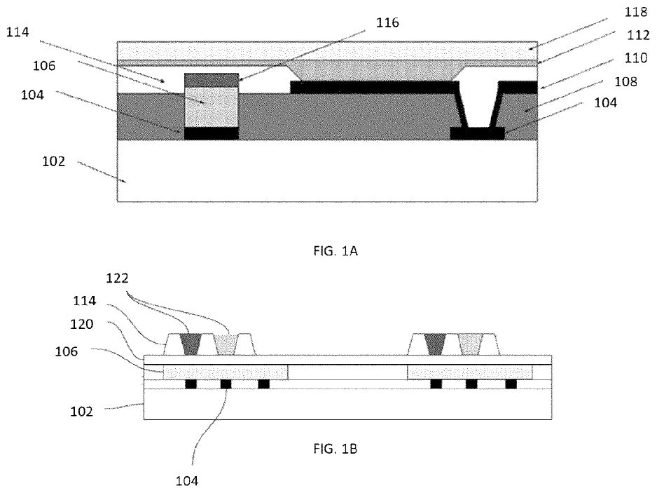

FIG. 1A shows an example of integrating a transferred microdevice 106 with an electro-optical thin film device 112 in a hybrid structure. This is an example of an integrated micro-LED tile that is later picked and placed into an array of tiles. It should be obvious to those in the art there are many ways to create micro-LED tiles and integrate them in an array of tiles, as per US20160218143A1—Microdevice integration into system substrate. A receiver substrate 102 and contact pads 104 upon which the microdevice 106 arrays are transferred and into which the thin film electro-optical device is integrated in a number of hybrid structure embodiments. Microdevice 106 may be transferred and bonded to the bonding pad 104 of the receiver substrate 100. In one case, a dielectric layer 108 is formed over the substrate 102 to cover the exposed electrodes and conductive layers. Lithography and etching may be used to pattern the dielectric layer 108. Conductive layer 110 is then deposited and patterned to form the bottom electrode of the thin film electro-optical device 112. If there is no risk of unwanted coupling between bottom electrode 110 and other conductive layers in the receiver substrate, the dielectric layer 108 may be eliminated. However, this dielectric layer can also act as a planarization layer to offer better fabrication of electro-optical devices 112. A bank layer 114 is deposited on the substrate 102 to cover the edges of the electrode 110 and the microdevice 106. Thin film electro-optical device 112 is then formed over this structure. Organic LED (OLED) devices are an example of a thin film electro-optical device that may be formed using different techniques such as but not limited to shadow mask, lithography, and printing patterning. Finally, the top electrode 118 of the electro-optical thin film device 112 is deposited and patterned if needed. In an embodiment where the microdevices' 106 thickness is significantly high, cracks or other structural problems may occur within the bottom electrode 110. In these embodiments, a planarization layer may be used in conjunction with or without the dielectric layer 108 to address this issue.

In another embodiment, the microdevice 106 can have a device electrode 116. This electrode can be common between other microdevices 106 in the system substrate. In this case, the planarization layer (if present) and/or bank structure 114 covers the electrode 116 to avoid any shorts between the electro-optical device 112 and device electrode 116.

FIG. 1B illustrates structures where the device is shared between a few pixels (or sub-pixels) after post-processing to deposit a common electrode and color conversion layers. Here the microdevice 106 is not fully patterned, but the horizontal condition is engineered so that the contacts 104 define the area allocated to each pixel. The system substrate 102 with contact pads 104 and a donor substrate with microdevices 106. After the microdevices 106 are transferred to system substrate 102, one can do post-processing, such as depositing common electrode 120, color conversion layers 122, color filters, and so on. However, the methods described in this disclosure and other possible methods can be used.

It is possible to add the color conversion layers as described into pixel (or sub-pixel) active areas after forming the active area. This can offer a higher fill factor and higher performance and avoid color leaking from the side pixel (or sub-pixel) if the active area of the pixel (or sub-pixel) is covered by reflective layers. The microdevices 106 are grown on a buffer/sacrificial layer in another embodiment.

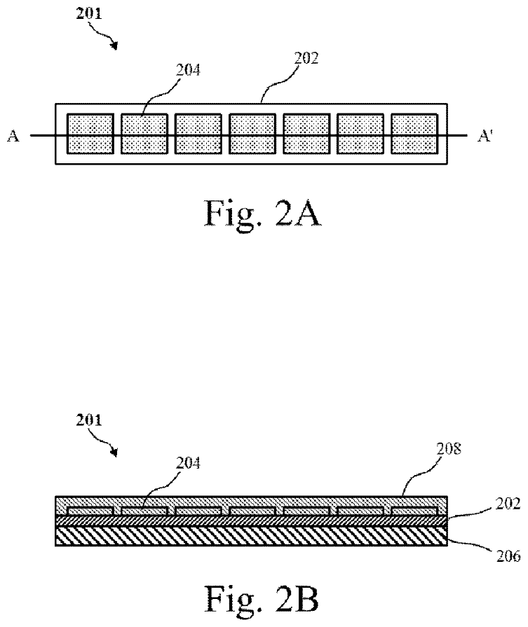

FIG. 2 (Comprising FIGS. 2A and 2B) displays an embodiment of a rigid flat Micro-LED for exterior strip lighting. FIG. 2A displays an over-the-top view of an embodiment of a rigid flat micro-LED for exterior strip lighting for a vehicle. The figure displays the micro-LED strip 201, which may include a rigid substrate 202, a series of micro-LED tiles 204, an adhesive strip 206, and a protective layer 208 to produce external lighting for a vehicle. The micro-LED strip 201 may contain a density of micro-LED tiles 204 in a series that can produce light visible as aesthetic lighting in any color or be made to be a programable color. The micro-LED strip 201 may be attached to the vehicle through the adhesive strip. The micro-LED strip 201 may be produced at any length to provide the required aesthetic lighting. The micro-LED strip 201 may contain micro-LED tiles 204 that are produced in a plurality of sizes to increase the width of the micro-LED strip 201 to provide the required aesthetic lighting needed. In some embodiments, the micro-LED strip 201 may contain the microdevice, such as the micro-LED tile 204, a contact pad, a circuit layer, and a rigid substrate 202, and encased in a protective layer 208. The rigid substrate 202 may be made of glass, silicon, plastics, or other commonly used material. The rigid substrate 202 may also have active electronic components such as but not limited to transistors, resistors, capacitors, or any other electronic component commonly used in a system substrate. In some cases, the rigid substrate 202 may be a rigid substrate 202 with electrical signal rows and columns. In one example, the rigid substrate 202 may be a sapphire substrate with LED layers grown monolithically on top of it, and the rigid substrate 202 may be a backplane with circuitry to derive micro-LED devices. The micro-LED tiles 204 contain a plurality of miniature LED (light emitting diodes) arrays, with each micro-LED functioning as a pixel and can be driven to emit light. Micro-LEDs comprise several microscopic LEDs, which self-illuminate per display pixel. Micro-LED is a modular technology. For example, panels are made up of tiny red, green, and blue LEDs and are connected to make one larger whole. In some embodiments, the micro-LED tiles 204 may be produced in a plurality of sizes to increase the width of the micro-LED strip 201. The adhesive strip 206 may be a strip with a substance, such as glue, starch, paste, mucilage, etc., that bonds the micro-LED strip 201 to another material, such as the exterior of the vehicle, to provide aesthetic lighting, by adhering to the surface of each. The protective layer 208 may be an enclosure to protect the micro-LED strip 201 from environmental elements or conditions. The protective layer 208 may be made of glass, silicon, plastics, etc., in which an anti-glare protective film covers the micro-LED strip 201 and the micro-LED tiles 204. For example, the protective layer 208 may be SiO2, silicon dioxide, or another suitable material which may be deposited over the micro-LED tiles 204 and/or micro-LED strip 201 by physical vapor deposition, chemical vapor deposition, or a spin-on process.

FIG. 2B displays a cross-sectional view of an embodiment of a rigid flat micro-LED for exterior strip lighting for a vehicle. The micro-LED strip 201 includes the adhesive strip 206 positioned on the bottom of the micro-LED strip 201 underneath but connected or bonded to the rigid substrate 202. The rigid substrate 202 is positioned on top of the adhesive layer 206, and the series of individual micro-LED tiles 204 are positioned on top of the substrate 202, as well as being in contact with the protective layer 208 from the spacing between the micro-LED tiles 204. The micro-LED tiles 204 are positioned on top of the substrate 202 and encased in the protective layer 208, which is positioned on top of the micro-LED tiles 204 and the substrate 202.

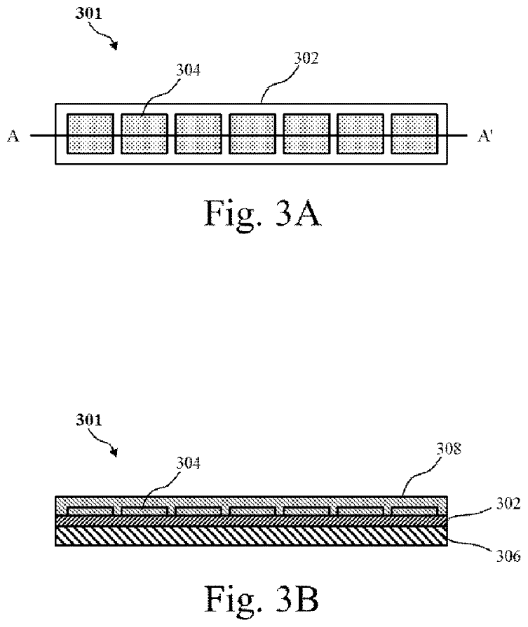

FIG. 3 displays an embodiment of a flexible flat Micro-LED for exterior strip lighting. FIG. 3A displays an over-the-top view of an embodiment of a flexible flat micro-LED for exterior strip lighting for a vehicle. The figure displays the micro-LED strip 301, which may include a flexible substrate 302, a series of micro-LED tiles 304, an adhesive strip 306, and a protective layer 308 to produce external lighting for a vehicle. The micro-LED strip 301 may contain a density of micro-LED tiles 304 in a series that can produce light visible as aesthetic lighting in any color or be made to be a programmable color. The micro-LED strip 301 may be attached to the vehicle through the adhesive strip 306. The micro-LED strip 301 may be produced at any length to provide the required aesthetic lighting. The micro-LED strip 301 may contain micro-LED tiles 304 that are produced in a plurality of sizes to increase the width of the micro-LED strip 301 to provide the required aesthetic lighting needed. In some embodiments, the micro-LED strip 301 may contain the microdevice, such as the micro-LED tile 304, a contact pad, a circuit layer, and a flexible substrate 302, and encased in a protective layer 308. The flexible substrate 302 may be made of glass, silicon, plastics, or other commonly used material. The flexible substrate 302 may also have active electronic components such as but not limited to transistors, resistors, capacitors, or any other electronic component commonly used in a system substrate. In some cases, the flexible substrate 302 may be a flexible substrate with electrical signal rows and columns. In one example, the flexible substrate 302 may be a sapphire substrate with LED layers grown monolithically on top of it, and the flexible substrate 302 may be a backplane with circuitry to derive micro-LED devices. The micro-LED tiles 304 contain a plurality of miniature LED (light emitting diodes) arrays, with each micro-LED functioning as a pixel and can be driven to emit light. Micro-LEDs comprise several microscopic LEDs, which self-illuminate per display pixel. Micro-LED is a modular technology. For example, panels are made up of a series of tiny red, green, and blue LEDs and are connected together to make one larger whole. In some embodiments, the micro-LED tiles 304 may be produced in a plurality of sizes to increase the width of the micro-LED strip 301. In some embodiments, the micro-LED tiles 304 may be produced to flex, twist, stretch, etc., to match or exceed the flexibility of the micro-LED strip 304. The adhesive strip 306 may be a strip with a substance, such as glue, starch, paste, mucilage, etc., that bonds the micro-LED strip 301 to another material, such as the vehicle's exterior, to provide aesthetic lighting, by adhering to the surface of each. The protective layer 308 may be an enclosure to protect the micro-LED strip 301 from environmental elements or conditions. The protective layer 308 may be made of glass, silicon, plastics, etc., in which an anti-glare protective film covers the micro-LED strip 301 and the micro-LED tiles 304. For example, the protective layer 308 may be SiO2, silicon dioxide, or another suitable material which may be deposited over the micro-LED tiles 304 and/or micro-LED strip 301 by physical vapor deposition, chemical vapor deposition, or a spin-on process. The protective layer 308 may be produced to match or enhance the flexibility of the micro-LED strip 301. In some embodiments, the protective layer 308 may cover the individual micro-LED tiles 304 but not the entire micro-LED strip to enhance the flexibility of the micro-LED strip 301. FIG. 3B displays a cross-sectional view of an embodiment of a flexible flat micro-LED for exterior strip lighting for a vehicle. The micro-LED strip 301 includes the adhesive strip 306 positioned on the bottom of the micro-LED strip 301 underneath but connected or bonded to the rigid substrate 302. The rigid substrate 302 is positioned on top of the adhesive layer 306, and the series of individual micro-LED tiles 304 are positioned on top of the substrate 302 and in contact with the protective layer 308 from the spacing between the micro-LED tiles 304. The micro-LED tiles 304 are positioned on top of the substrate 302 and encased in the protective layer 308, which is positioned on top of the micro-LED tiles 304 and the substrate 302.

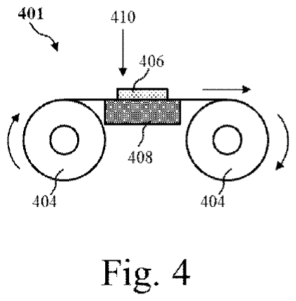

FIG. 4 displays an embodiment of making micro-LED flexible exterior strip units. The figure displays a roll-to-roll manufacturing method of micro-LEDs in which the micro-LED tile 406 is attached to a flexible substrate from the supply wheel 402. The roll-to-roll micro-LED tile attachment on a flexible substrate 401 may be the process of creating micro-LED strips on a roll of a flexible substrate such as glass, silicon, plastics, etc. Roll-to-roll processing is a fabrication method used in manufacturing that embeds, coats, prints, or laminates varying applications onto a flexible rolled substrate material as that material is fed continuously from one roller onto another. The roll-to-roll micro-LED tile attachment on a flexible substrate 401 may include a supply wheel of the flexible substrate 402, the take up reel 404, a plurality of micro-LED tiles 406, the die attach table 408, the attachment 410 or bonding of the micro-LED tile 406 to the flexible substrate on the die attach table 408. The supply wheel of the flexible substrate 402 provides a continuous supply of the flexible substrate to the die attach table 408 by continuously unrolling the flexible substrate onto an assembly line and then attachment 410 of the micro-LED tile 406. The take up reel 404 continuously reels in the finished micro-LED strip that contains the micro-LED tile 406 attached or bonded to the flexible substrate. The micro-LED tiles 404 are attached to the flexible substrate provided by the supply wheel of the flexible substrate 202 by the attachment 410 on the die attach table 408. The micro-LED tiles 404 contain a plurality of miniature LED (light emitting diodes) arrays, with each micro-LED functioning as a pixel and can be driven to emit light. Micro-LEDs comprise several microscopic LEDs, which self-illuminate per display pixel. Micro-LED is a modular technology. For example, panels are made up of a series of tiny red, green, and blue LEDs and are connected together to make one larger whole. In some embodiments, the micro-LED tiles 404 may be produced in a plurality of sizes to increase the width of the micro-LED strip. In some embodiments, the micro-LED tiles 404 may be produced to flex, twist, stretch, etc., to match or exceed the flexibility of the micro-LED strip 404. The die attach table 408 may assist in the bonding process of the micro-LED tile 406 to the flexible substrate by applying heat and pressure against the attachment 410 to secure the micro-LED tile 406 to the flexible substrate. The attachment 410 may be the bonding or securing of the micro-LED tile 406 to the flexible substrate, which may include a predetermined amount of time, pressure, and heat supplied by the die attach table 408. In some embodiments, the process may include providing a protective layer over the micro-LED tile 406, which may be an enclosure to protect the micro-LED strip from environmental elements or conditions. The protective layer may be made of glass, silicon, plastics, etc., in which an anti-glare protective film covers the micro-LED strip and the micro-LED tiles 406. For example, the protective layer may be SiO2, silicon dioxide, or another suitable material which may be deposited over the micro-LED tiles 406 and/or micro-LED strip by physical vapor deposition, chemical vapor deposition, or a spin-on process.

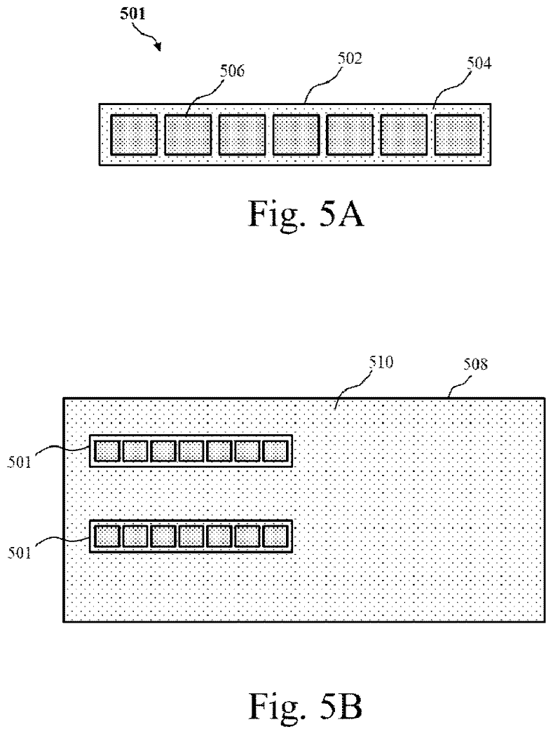

FIG. 5 (Comprising 5A and 5B) displays embodiments of a micro-LED with a colored substrate that matches the color of a vehicle. FIG. 5A displays an embodiment of a micro-LED with a substrate colored to be the same color as the vehicle. The figure displays the micro-LED colored strip 501, which includes a rigid or flexible substrate 502, a colored substrate 504, and a series of micro tiles 506 positioned on the colored substrate 504. The colored micro-LED strip 501 may include a flexible or rigid substrate 502, a series of micro-LED tiles 506, an adhesive strip, and a protective layer to produce external aesthetic lighting for a vehicle. The micro-LED strip 501 may contain a density of micro-LED tiles 506 in a series that can produce light visible as aesthetic lighting in any color or be made to be a programmable color. The colored micro-LED strip 501 may be attached to the vehicle through an adhesive strip, which may be the same as the color of the vehicle. The colored micro-LED strip 501 may be produced at any length to provide the required aesthetic lighting. The colored micro-LED strip 501 may contain micro-LED tiles 506 that are produced in a plurality of sizes to increase the width of the colored micro-LED strip 501 to provide the required aesthetic lighting needed. In some embodiments, the colored micro-LED strip 501 may contain the microdevice, such as the micro-LED tile 506, a contact pad, a circuit layer, and a rigid or flexible colored substrate 502, encased in a protective layer. The rigid or flexible colored substrate 502 may be made of glass, silicon, plastics, or other commonly used material. The rigid or flexible colored substrate 502 may be produced in a plurality of colors to match the plurality of colors of vehicles, such as black, white, blue, red, silver, etc. The rigid or flexible colored substrate 502 allows the colored micro-LED strip 501 to blend into the vehicle's color since the color of the rigid or flexible colored substrate 502 matches the color of the vehicle. The rigid or flexible colored substrate 502 may also have active electronic components such as but not limited to transistors, resistors, capacitors, or any other electronic component commonly used in a system substrate. In some cases, the rigid or flexible colored substrate 502 may be a rigid or flexible colored substrate 502 with electrical signal rows and columns. In one example, the rigid or flexible colored substrate 502 may be a sapphire substrate with LED layers grown monolithically on top of it, and the rigid or flexible colored substrate 502 may be a backplane with circuitry to derive micro-LED devices. The color of the vehicle 510 may be the property possessed by a vehicle of producing different sensations on the eye as a result of the way the object reflects or emits light, such as black, white, blue, red, silver, etc. The micro-LED tiles 506 contain a plurality of miniature LED (light emitting diodes) arrays, with each micro-LED functioning as a pixel and can be driven to emit light. Micro-LEDs comprise several microscopic LEDs, which self-illuminate per display pixel. Micro-LED is a modular technology. For example, panels are made up of a series of tiny red, green, and blue LEDs and are connected together to make one larger whole. In some embodiments, the micro-LED tiles 506 may be produced in a plurality of sizes to increase the width of the colored micro-LED strip 501. In some embodiments, the micro-LED tiles 506 may be produced to flex, twist, stretch, etc., to match or exceed the flexibility of the colored micro-LED strip 506. The vehicle 508 may be a thing used for transporting people or goods, especially on land, such as an automobile, car, truck, cart, bus, van, SUV, motorcycle, etc., first responder vehicles, such as police car, fire engine, ambulance, etc., off-roading vehicles, such as ATVs (all-terrain vehicles), UTV (utility task vehicles), sandrails, dune buggy, enduro bikes or off-road motorcycles or dirt bikes, trail bikes, etc. FIG. 5B displays an embodiment of a micro-LED with a substrate colored to be the same color as the vehicle positioned on a vehicle. The figure displays the colored micro-LED strip 501 positioned on the vehicle 508 and colored the same color as the vehicle 510. The colored micro-LED strip 501 may include a flexible or rigid substrate 502, a series of micro-LED tiles 506, an adhesive strip, and a protective layer to produce external aesthetic lighting for a vehicle. The micro-LED strip 501 may contain a density of micro-LED tiles 506 in a series that can produce light visible as aesthetic lighting in any color or be made to be a programmable color. The colored micro-LED strip 501 may be attached to the vehicle through an adhesive strip, which may be the same as the color of the vehicle. The colored micro-LED strip 501 may be produced at any length to provide the required aesthetic lighting. The colored micro-LED strip 501 may contain micro-LED tiles 506 that are produced in a plurality of sizes to increase the width of the colored micro-LED strip 501 to provide the required aesthetic lighting needed. In some embodiments, the colored micro-LED strip 501 may contain the microdevice, such as the micro-LED tile 506, a contact pad, a circuit layer, and a rigid or flexible colored substrate 502, encased in a protective layer. The color of the vehicle 510 may be the property possessed by a vehicle of producing different sensations on the eye as a result of the way the object reflects or emits light, such as black, white, blue, red, silver, etc. The vehicle 508 may be a thing used for transporting people or goods, especially on land, such as an automobile, car, truck, cart, bus, van, SUV, motorcycle, etc., first responder vehicles, such as police car, fire engine, ambulance, etc., off-roading vehicles, such as ATVs (all-terrain vehicles), UTV (utility task vehicles), sandrails, dune buggy, enduro bikes or off-road motorcycles or dirt bikes, trail bikes, etc.

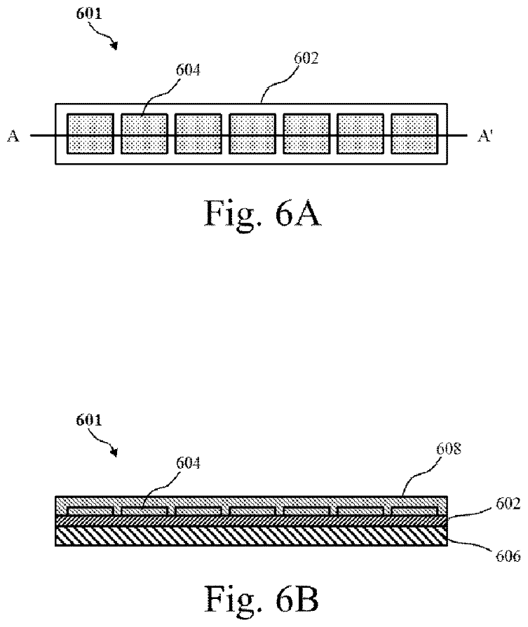

FIG. 6 displays an embodiment of a micro-LED strip with a transparent substrate to match the clear glass of a vehicle. FIG. 6A displays an embodiment of a rigid or flexible micro-LED strip with a transparent substrate that matches the transparency of glass or windows of a vehicle. The transparent micro-LED strip 601 may include a flexible or rigid substrate 602, a series of micro-LED tiles 604, an adhesive strip 606, and a protective layer 608 to produce external aesthetic lighting for a vehicle. The transparent micro-LED strip 601 may contain a density of micro-LED tiles 604 in a series that can produce light visible as aesthetic lighting in any color or be made to be a programable color. The transparent micro-LED strip 601 may be attached to the vehicle through an adhesive strip 606. The transparent micro-LED strip 601 may be produced at any length to provide the required aesthetic lighting. The transparent micro-LED strip 601 may contain micro-LED tiles 604 that are produced in a plurality of sizes to increase the width of the colored micro-LED strip 601 to provide the required aesthetic lighting needed. In some embodiments, the transparent micro-LED strip 601 may contain the microdevice, such as the micro-LED tile 604, a contact pad, a circuit layer, and a rigid or flexible transparent substrate 602, and encased in a protective layer 608. The transparent substrate 602 may be made of glass, silicon, plastics, or other commonly used material. The transparent substrate 602 may be either a flexible transparent substrate 602 or a rigid transparent substrate 602. The transparent substrate 602 allows the transparent micro-LED strip 601 to blend into the vehicle's color since the transparency of the rigid or flexible transparent substrate 602 would visually match the color of the vehicle. The transparent substrate 602 may also have active electronic components such as but not limited to transistors, resistors, capacitors, or any other electronic component commonly used in a system substrate. In some cases, the transparent substrate 602 may be a rigid or flexible transparent substrate 602 with electrical signal rows and columns. In one example, the rigid or flexible transparent substrate 602 may be a sapphire substrate with LED layers grown monolithically on top of it, and the rigid or flexible transparent substrate 602 may be a backplane with circuitry to derive micro-LED devices. The micro-LED tiles 606 contain a plurality of miniature LED (light emitting diodes) arrays, with each micro-LED functioning as a pixel and can be driven to emit light. Micro-LEDs comprise several microscopic LEDs, which self-illuminate per display pixel. Micro-LED is a modular technology. For example, panels are made up of a series of tiny red, green, and blue LEDs and are connected together to make one larger whole. In some embodiments, the micro-LED tiles 606 may be produced in a plurality of sizes to increase the width of the transparent micro-LED strip 601. In some embodiments, the micro-LED tiles 606 may be produced to flex, twist, stretch, etc., to match or exceed the flexibility of the transparent micro-LED strip 606. The adhesive strip 606 may be a strip with a transparent substance, such as glue, starch, paste, mucilage, etc., that bonds the transparent micro-LED strip 601 to another material, such as the exterior of the vehicle to provide aesthetic lighting, by adhering to the surface of each. The protective layer 608 may be an enclosure to protect the transparent micro-LED strip 601 from environmental elements or conditions. The protective layer 608 may be made of a transparent material, such as glass, silicon, plastics, etc., in which an anti-glare protective film covers the transparent micro-LED strip 601 and the micro-LED tiles 604. For example, the protective layer 608 may be SiO2, silicon dioxide, or another suitable material which may be deposited over the micro-LED tiles 604 and/or transparent micro-LED strip 601 by physical vapor deposition, chemical vapor deposition, or a spin-on process. FIG. 6B displays a cross-sectional view of an embodiment of a transparent micro-LED strip 601 for exterior strip lighting for a vehicle. The transparent micro-LED strip 601 includes the adhesive strip 606 positioned on the bottom of the transparent micro-LED strip 601 underneath but connected or bonded to the transparent substrate 602. The transparent substrate 602 is positioned on top of the transparent adhesive layer 606, and the series of individual micro-LED tiles 604 are positioned on top of the transparent substrate 602 as well as being in contact with the transparent protective layer 608 from the spacing between the micro-LED tiles 604. The micro-LED tiles 604 are positioned on top of the transparent substrate 602 and are encased in the transparent protective layer 608, which is positioned on top of the micro-LED tiles 604 and the transparent substrate 602.

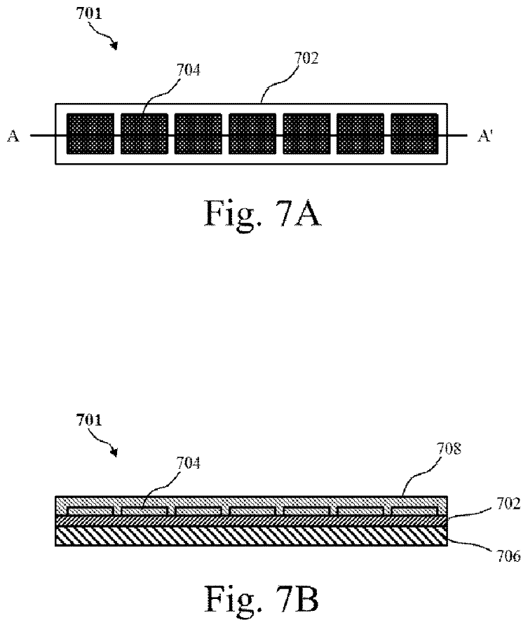

FIG. 7 displays an embodiment of a micro-LED strip with a color pixel array in an exterior strip lighting unit for vehicles. FIG. 7A displays an over-the-top view of an embodiment of a flat micro-LED with a color pixel array for exterior strip lighting for a vehicle. The figure displays the micro-LED strip 701, which may include a substrate 702, a series of micro-LED tiles 704, an adhesive strip 706, and a protective layer 708 to produce external lighting for a vehicle. The micro-LED strip 701 may contain a density of micro-LED tiles 704 in a series that can produce light visible as aesthetic lighting in any color or be made to be a programmable color. The micro-LED strip 701 may be attached to the vehicle through the adhesive strip 706. The micro-LED strip 701 may be produced at any length to provide the required aesthetic lighting. The micro-LED strip 701 may contain micro-LED tiles 704 that are produced in a plurality of sizes to increase the width of the micro-LED strip 701 to provide the required aesthetic lighting needed. In some embodiments, the micro-LED strip 701 may contain the microdevice, such as the micro-LED tile 704, a contact pad, a circuit layer, and a substrate 702, and encased in a protective layer 708. The substrate 702 may be made of glass, silicon, plastics, or other commonly used material. The substrate 702 may also have active electronic components such as but not limited to transistors, resistors, capacitors, or any other electronic component commonly used in a system substrate. In some cases, the substrate 702 may be a substrate 702 with electrical signal rows and columns. In one example, the substrate 702 may be a sapphire substrate with LED layers grown monolithically on top of it and the substrate 702 may be a backplane with circuitry to derive micro-LED devices. In some embodiments, the substrate 702 may be a flexible or rigid substrate 702. In some embodiments, the substrate 702 may be transparent or colored to match a vehicle's exterior or interior component. The micro-LED tiles 704 contain a plurality of miniature LED (light emitting diodes) arrays, with each micro-LED functioning as a pixel and can be driven to emit light. Micro-LEDs comprise several microscopic LEDs, which self-illuminate per display pixel. Micro-LED is a modular technology. For example, panels are made up of a series of tiny red, green, and blue LEDs and are connected together to make one larger whole. The micro-LED tiles 704 may contain a colored pixel array to allow each micro-LED tile 704 to produce different color patterns or to produce different color patterns within each micro-LED tile 704. In some embodiments, the micro-LED tiles 704 may be individually controlled to produce various color patterns on a single micro-LED strip 701. In some embodiments, the micro-LED tiles 704 may be produced in a plurality of sizes to increase the width of the micro-LED strip 701. In some embodiments, the micro-LED tiles 704 may be produced to flex, twist, stretch, etc., to match or exceed the flexibility of the micro-LED strip 704. The adhesive strip 706 may be a strip with a substance, such as glue, starch, paste, mucilage, etc., that bonds the micro-LED strip 701 to another material, such as the vehicle's exterior, to provide aesthetic lighting, by adhering to the surface of each. The protective layer 708 may be an enclosure to protect the micro-LED strip 701 from environmental elements or conditions. The protective layer 708 may be made of glass, silicon, plastics, etc., in which an anti-glare protective film covers the micro-LED strip 701 and the micro-LED tiles 704. For example, the protective layer 708 may be SiO2, silicon dioxide, or another suitable material which may be deposited over the micro-LED tiles 704 and/or micro-LED strip 701 by physical vapor deposition, chemical vapor deposition, or a spin-on process. The protective layer 708 may be produced to match or enhance the flexibility of the micro-LED strip 701. In some embodiments, the protective layer 708 may cover the individual micro-LED tiles 704 but not the entire micro-LED strip to enhance the flexibility of the micro-LED strip 701. FIG. 7B displays a cross-sectional view of an embodiment of a flat micro-LED with a color pixel array for exterior strip lighting for a vehicle. The micro-LED strip 701 includes the adhesive strip 706 positioned on the bottom of the micro-LED strip 701 underneath but connected or bonded to the rigid substrate 702. The rigid substrate 702 is positioned on top of the adhesive layer 706, and the series of individual micro-LED tiles 704 are positioned on top of the substrate 702 as well as being in contact with the protective layer 708 from the spacing between the micro-LED tiles 704. The micro-LED tiles 704 are positioned on top of the substrate 702 and are encased in the protective layer 708, which is positioned on top of the micro-LED tiles 704 as well as the substrate 702.

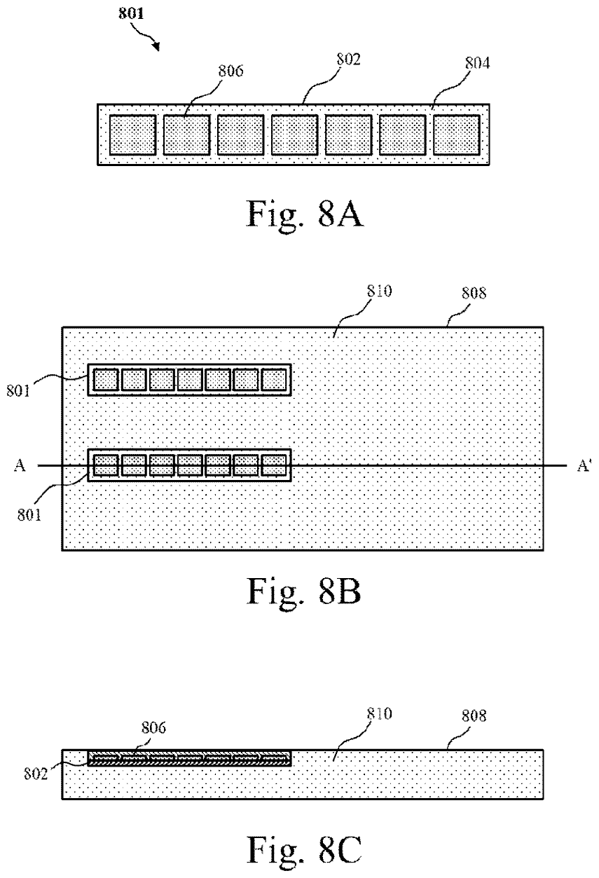

FIG. 8 displays embodiments of a micro-LED with a color pixel array integrated into a body part attachment of a vehicle. FIG. 8A displays an embodiment of the integrated micro-LED strip 801 that is enclosed in a vehicle's body part, component, accessory, etc. The integrated micro-LED strip 801 may include a rigid substrate 802, micro-LED tiles 806, and a protective layer to produce external lighting for a vehicle. The micro-LED strip 801 may contain a density of micro-LED tiles 804 in a series that can produce light visible as aesthetic lighting in any color or be made to be a programable color. The micro-LED strip 801 may be attached to the vehicle by being embedded or encased in the vehicle's body party, component, accessory, etc. The micro-LED strip 801 may be produced at any length to provide the required aesthetic lighting. The micro-LED strip 801 may contain micro-LED tiles 804 that are produced in a plurality of sizes to increase the width of the micro-LED strip 801 to provide the required aesthetic lighting needed. In some embodiments, the micro-LED strip 801 may contain the microdevice, such as the micro-LED tile 804, a contact pad, a circuit layer, and a substrate 802, and encased in a protective layer. The rigid substrate 802 may be made of glass, silicon, plastics, or other commonly used material. The rigid substrate 802 may also have active electronic components such as but not limited to transistors, resistors, capacitors, or any other electronic component commonly used in a system substrate. In some cases, the rigid substrate 802 may be a substrate with electrical signal rows and columns. In one example, the rigid substrate 802 may be a sapphire substrate with LED layers grown monolithically on top of it, and the rigid substrate 802 may be a backplane with circuitry to derive micro-LED devices. In some embodiments, the rigid substrate 802 may be a colored rigid substrate 802 that matches the color of the vehicle's body part, component, accessory, etc. The micro-LED tiles 804 contain a plurality of miniature LED (light emitting diodes) arrays, with each micro-LED functioning as a pixel and can be driven to emit light. Micro-LEDs comprise several microscopic LEDs, which self-illuminate per display pixel. Micro-LED is a modular technology. For example, panels are made up of a series of tiny red, green, and blue LEDs and are connected together to make one larger whole. The micro-LED tiles 804 may contain a colored pixel array to allow each micro-LED tile 804 to produce different color patterns or different color patterns within each micro-LED tile 804. In some embodiments, the micro-LED tiles 804 may be individually controlled to produce various color patterns on a single micro-LED strip 801. In some embodiments, the micro-LED tiles 804 may be produced in a plurality of sizes to increase the width of the micro-LED strip 801. In some embodiments, the micro-LED tiles 804 may be produced to flex, twist, stretch, etc., to match or exceed the flexibility of the micro-LED strip 804. FIG. 8B displays an over-the-top view of the integrated micro-LED strip 801 enclosed in a vehicle's body part, component, accessory, etc. The integrated micro-LED strip 801 may include a rigid substrate 802, micro-LED tiles 806, and a protective layer to produce external lighting for a vehicle. The micro-LED strip 801 may contain a density of micro-LED tiles 804 in a series that can produce light visible as aesthetic lighting in any color or be made to be a programable color. The micro-LED strip 801 may be attached to the vehicle by being embedded or encased in the vehicle's body party, component, accessory, etc. The micro-LED strip 801 may be produced at any length to provide the required aesthetic lighting. The micro-LED strip 801 may contain micro-LED tiles 804 that are produced in a plurality of sizes to increase the width of the micro-LED strip 801 to provide the required aesthetic lighting needed. In some embodiments, the micro-LED strip 801 may contain the microdevice, such as the micro-LED tile 804, a contact pad, a circuit layer, and a substrate 802, and encased in a protective layer. The color of the vehicle 804 may be the property possessed by a vehicle of producing different sensations on the eye as a result of the way the object reflects or emits light, such as black, white, blue, red, silver, etc. The body part 808 of the vehicle may be any exterior or interior component, accessory, or section, of the vehicle. For example, the exterior body part 808 may be, but not limited to, the door, hood, trunk, bumper, bumper end, valance panel, inner fender, fender, cowl panel, lower door skin, rocker panel, dog leg, wheel arch panel, wheelhouse, quarter panel, fender extension panel, header panel, firewall, fender flare, etc. For example, the interior body part 808 may be, but not limited to, the dashboard, steering wheel, horn, headset, glove compartment, door handles, seats, headrests, floor carpet, hardwood floor, tibia pad, headliner, door trim, door opening trim, door weather strip, scuff plate ornament, assist grip, sun visor, rear shelf, etc. FIG. 8C displays a cross-sectional view of the integrated micro-LED strip 801 that is enclosed in a vehicle's body part, component, accessory, etc. The figure displays the micro-LED tiles 806 positioned on top of the rigid substrate 802 enclosed or encased in the body part 808 of the vehicle. The micro-LED tiles 804 contain a plurality of miniature LED (light emitting diodes) arrays, with each micro-LED functioning as a pixel and can be driven to emit light. Micro-LEDs comprise several microscopic LEDs, which self-illuminate per display pixel. Micro-LED is a modular technology. For example, panels are made up of a series of tiny red, green, and blue LEDs and are connected together to make one larger whole. The micro-LED tiles 804 may contain a colored pixel array to allow each micro-LED tile 804 to produce different color patterns or different color patterns within each micro-LED tile 804. In some embodiments, the micro-LED tiles 804 may be individually controlled to produce various color patterns on a single micro-LED strip 801. In some embodiments, the micro-LED tiles 804 may be produced in a plurality of sizes to increase the width of the micro-LED strip 801. In some embodiments, the micro-LED tiles 804 may be produced to flex, twist, stretch, etc., to match or exceed the flexibility of the micro-LED strip 804. The rigid substrate 802 may be made of glass, silicon, plastics, or other commonly used material. The rigid substrate 802 may also have active electronic components such as but not limited to transistors, resistors, capacitors, or any other electronic component commonly used in a system substrate. In some cases, the rigid substrate 802 may be a substrate with electrical signal rows and columns. In one example, the rigid substrate 802 may be a sapphire substrate with LED layers grown monolithically on top of it, and the rigid substrate 802 may be a backplane with circuitry to derive micro-LED devices. In some embodiments, the rigid substrate 802 may be a colored rigid substrate 802 that matches the color of the vehicle's body part, component, accessory, etc. The color of the vehicle 810 may be the property possessed by a vehicle of producing different sensations on the eye as a result of the way the object reflects or emits light, such as black, white, blue, red, silver, etc. The body part 808 of the vehicle may be any exterior or interior component, accessory, or section of the vehicle. For example, the exterior body part 808 may be, but not limited to, the door, hood, trunk, bumper, bumper end, valance panel, inner fender, fender, cowl panel, lower door skin, rocker panel, dog leg, wheel arch panel, wheelhouse, quarter panel, fender extension panel, header panel, firewall, fender flare, etc. For example, the interior body part 808 may be, but not limited to, the dashboard, steering wheel, horn, headset, glove compartment, door handles, seats, headrests, floor carpet, hardwood floor, tibia pad, headliner, door trim, door opening trim, door weather strip, scuff plate ornament, assist grip, sun visor, rear shelf, etc.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A method to integrate aesthetic micro-LED lighting strip lighting strip for a transportation vehicle, the method comprising:
having a micro-LED strip with a substrate, a plurality of micro-LED tiles and a protective layer;
having an adhesive strip in the micro-LED strip;
having a connection means to connect the micro-LED tiles; and
wherein, the micro-LED lighting strip is attached to the transportation vehicle through the adhesive strip to provide a required lighting.

2. The method of claim 1, wherein the micro-LED strip 201 comprises a density of micro-LED tiles in a series to produce light visible as aesthetic lighting in any color or be made to be a programmable color.

3. The method of claim 1, wherein the micro-LED strip is produced at any length to provide the required lighting.

4. The method of claim 1, wherein the micro-LED strip 201 comprises micro-LED tiles produced in a plurality of sizes to increase a width of the micro-LED strip to provide the required lighting.

5. The method of claim 1, wherein the micro-LED strip comprises a microdevice, such as the micro-LED tile, a contact pad, a circuit layer, and a rigid substrate encased in the protective layer.

6. The method of claim 5, wherein the rigid substrate is made of glass, silicon, or plastics wherein further, the rigid substrate also has active electronic components such as but not limited to transistors, resistors, capacitors, or any other electronic component commonly used in a system substrate.

7. The method of claim 5, wherein the rigid substrate is a rigid substrate with electrical signal rows and columns.

8. The method of claim 5, wherein the rigid substrate is a sapphire substrate with LED layers grown monolithically on top of it, and the rigid substrate is a backplane with a circuitry to derive micro-LED devices.

9. The method of claim 5, wherein the micro-LED tiles 204 contain a plurality of micro-LED arrays, with each micro-LED functioning as a pixel and is driven to emit light.

10. The method of claim 9, wherein the micro-LEDs comprise several microscopic LEDs, which self-illuminate per display pixel.

11. The method of claim 5, wherein panels are made up of tiny red, green, and blue micro-LEDs and are connected to make one larger whole.

12. The method of claim 1, wherein the adhesive strip is a strip with a substance, such as glue, starch, paste, mucilage that bonds the micro-LED strip to another material, such as the exterior of the vehicle, to provide lighting, by adhering to the surface of each.

13. The method of claim 5, wherein the protective layer is an enclosure to protect the micro-LED strip from environmental elements or conditions and wherein further the protective layer is made of either glass, silicon or plastics in which an anti-glare protective film covers the micro-LED strip and the micro-LED tiles.

14. The method of claim 13, wherein the protective layer if either SiO2, silicon dioxide deposited over the micro-LED tiles and/or micro-LED strip by a physical vapor deposition, a chemical vapor deposition, or a spin-on process.
